(19) United States
(12) Patent Application Publication
(10) Pub. No.: US 2011/0002124 A1
(43) Pub. Date: Jan. 6, 2011

(54) WIDE ANGLE LED LAMP STRUCTURE

(76) Inventors: Kun-Jung Chang, Kaohsiung County (TW); Ching-Yuan Juan, Kaohsiung County (TW); Kuo-Chun Lin, Kaohsiung County (TW); Ching-Huang Juan, Kaohsiung County (TW)

Correspondence Address: Muncy, Geissler, Olds & Lowe, PLLC, 4000 Legato Road, Suite 310, FAIRFAX, VA, 22033, US

(21) Appl. No.: 12/497,946

(22) Filed: Jul. 6, 2009

(51) Int. Cl. F21V 29/00

(52) U.S. Cl. 362/294

(57) ABSTRACT

A wide angle LED lamp structure provides a LED holder, which can be adjusted to have wide angle illumination range, embedded in a LED room of a heat dissipation base, cooperating with lamp cover and light reflection board, so that the illumination range becomes wider while maintaining the brightness even, and also the dazzle from LED lamp can be reduced. Besides, the LED holder can be replaced according to the different needs of illumination range, and the number of LED bulbs on the inclined plane of LED holder also can be varied in accordance with a user's demands, thereby enhancing the efficiency of each lamp.

### FIELD OF THE INVENTION

The present invention is related to a wide angle LED lamp structure, and more particularly to a lamp structure which utilizes the LED holder to adjust the illumination angle and the brightness.

### BACKGROUND OF THE INVENTION

In the market, most of LED lamps can not adjust the brightness and the illumination range due to the restriction of their fixed structure.

Conventionally, the number of LED bulbs in the lamp is constant which means it can not be reduced as demand changes and might increase cost and waste resource. Therefore, when there is the need to vary the number of LED bulbs, the only way is to replace by another lamp with required number of LED bulbs.

Besides, the conventional lamp always has fixed illumination angle and range, so that if the room for installing the lamp has insufficient height and wider space, the lamp might not illuminate the whole room, but if installing multiple lamps, the illumination ranges might be overlapped to cause uneven brightness and waste electricity.

### SUMMARY OF THE INVENTION

The object of the present invention is to solve the problems of non-adjustable illumination range and constant number of LED bulbs of the conventional LED lamp.

For achieving the object described above, the present invention utilizes an inclined angle of an LED holder to adjust the illumination range and reduce the dazzle through a reflection board and a lamp cover, and also controls the brightness of lamp by varying the number of LED bulbs on PCBs, so as to meet the requirements of energy saving and cost reduction.

The wide angle LED lamp structure of the present invention also can replace the LED holder for fixing PCBs by detachable holder pieces, so that the user can adjust the illumination range and brightness by replacing the holder so as to meet different demands, thereby reducing the cost.

Therefore, the wide angle LED lamp structure of the present invention is advantageous that:

1. The illumination range is wide while the brightness is even.

2. The number of LED bulbs can be adjusted to achieve energy saving and cost reduction.

3. The LED holder for fixing PCBs can be replaced to meet different needs of illumination range.

4. The dazzle of lamp can be effectively reduced by using the light reflection board and the lamp cover.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional schematic view of the present invention;

FIG. 2 is another three-dimensional schematic view of the present invention;

FIG. 3 is a three-dimensional view showing the heat dissipation base;

FIG. 4 is a schematic view showing the assembly of LED holder and PCBs;

FIG. 5 is a schematic view showing the assembling of the present invention;

FIG. 6A is a bottom view of the heat dissipation base;

FIG. 6B is a sectional view of line 6B-6B in FIG. 6A;

FIG. 6C is a partial magnification view of FIG. 6B; and

FIG. 7 is a schematic view showing the assembly of holder pieces and the heat dissipation base.

### DESCRIPTION OF THE PREFERRED EMBODIMENT

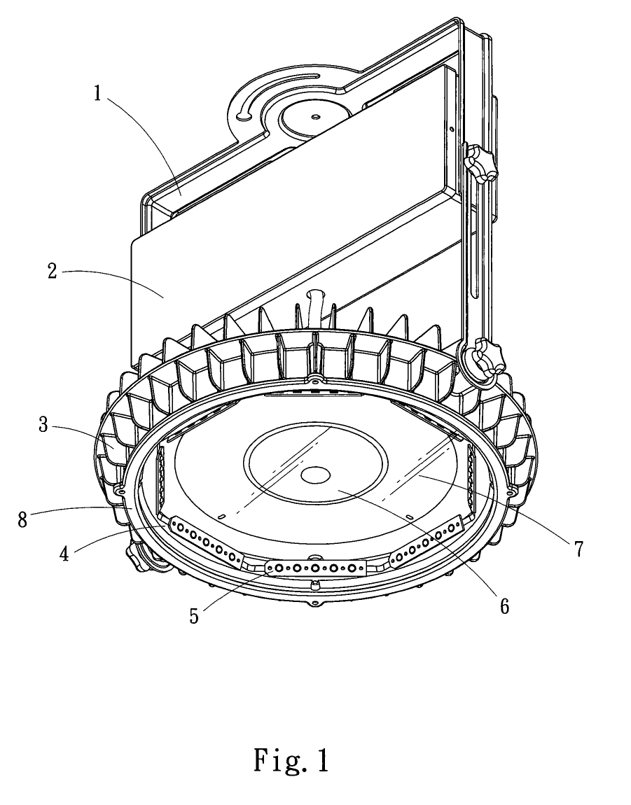

Please refer to FIG. 1. The wide angle LED lamp structure according to the present invention includes a fixture 1, a control box 2, a heat dissipation base 3, an LED holder 4, a plurality of PCBs 5, a light reflection board 6, a lamp cover 7, and a edge frame 8, wherein:

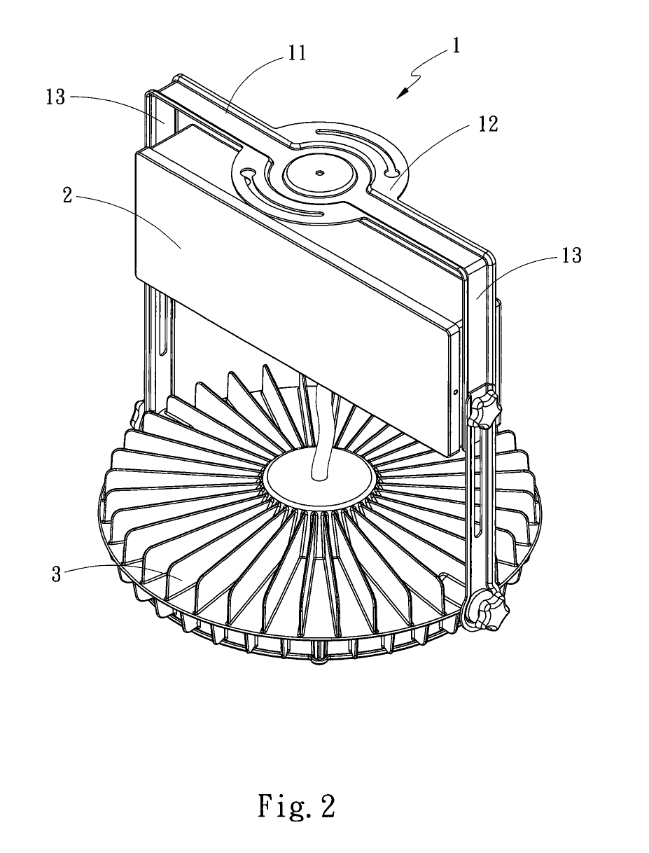

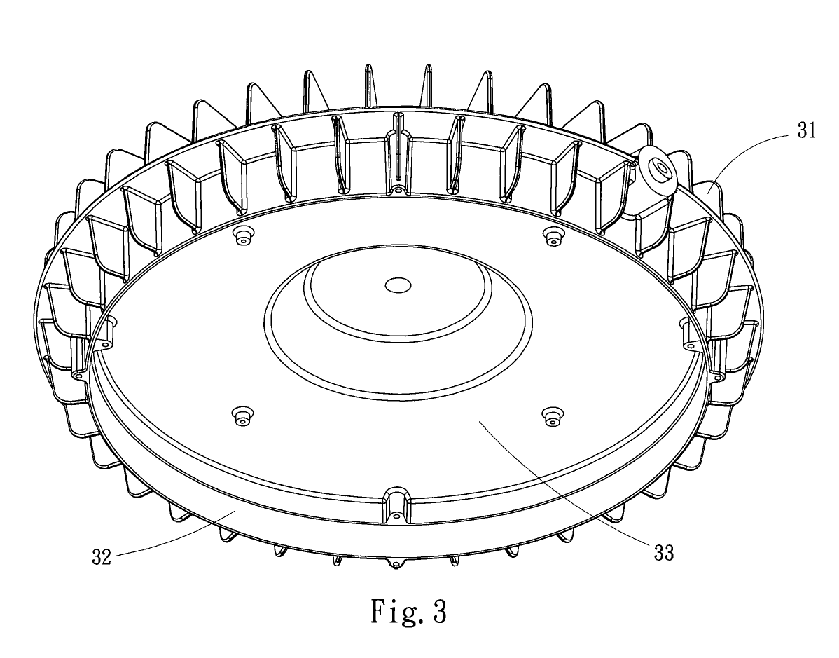

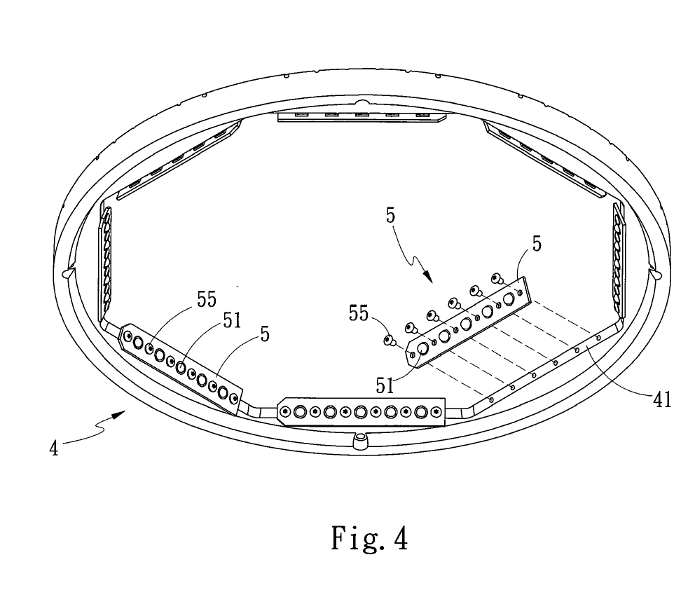

As shown in FIG. 2, FIG. 3 and FIG. 4, the fixture 1 includes a horizontal support 11 and two vertical supports 13 extended from two ends of the horizontal support 11, wherein a rotational disc 12 is mounted on the middle section of the horizontal support 11 for providing a turning function for the lamp as fixed on the wall. The control box 12 is mounted between the two vertical supports 13.

The heat dissipation base 3 is made of a metal having high heat dissipation efficiency, such as aluminum, copper and the likes. The heat dissipation base 3 is bolted between the two vertical supports 13 at the lower portion thereof, wherein the peripheral surface of the heat dissipation base 3 is surrounded by a plurality of heat dissipation fins 31, the bottom thereof has an LED room 32 with a light reflection room 33 located above the room 32.

The LED holder 4 is matched with the LED room 32 and is embedded and screwed in the LED room 32, wherein the LED holder 4 has a plurality of first inclined planes 41 mounted and surrounded at the inner side thereof. The LED holder 4 also can be integrally formed with the heat dissipation base 3.

Each of the PCBs 5 has a plurality of LED bulbs 51 mounted thereon, and the PCB 5 is fixed on the first inclined plane 41 of the LED holder 4 through fixing elements 55, such as screws, which are spaced at intervals corresponding to the LED bulbs 51, wherein the number of the LED bulbs 51 can be varied in accordance with the demands of energy saving and the required illumination range.

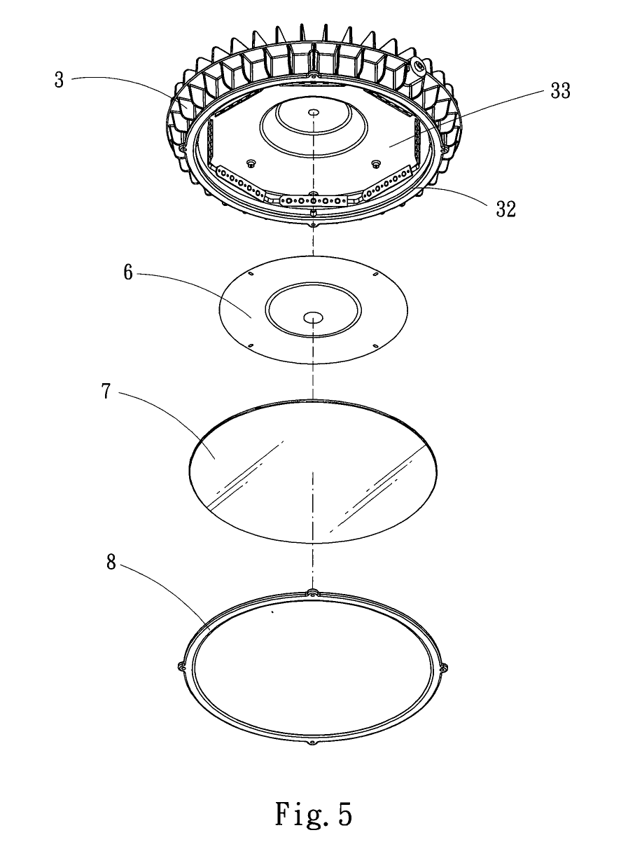

Please refer to FIG. 5. The light reflection board 6 is screwed in the reflection room 33 for reflecting the light from the LED bulbs 51 so as to average the brightness of the illumination range.

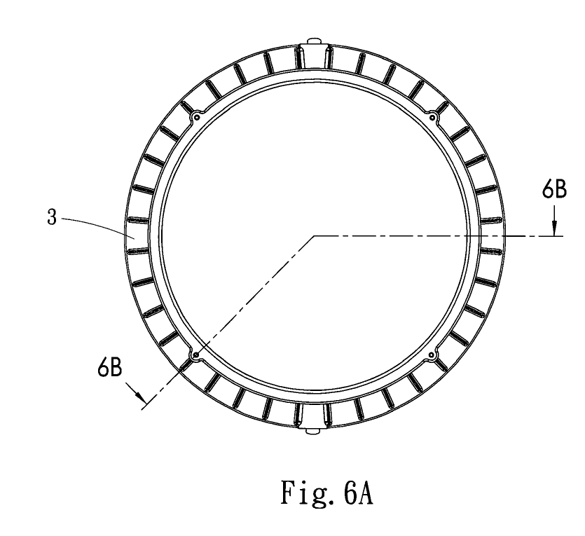

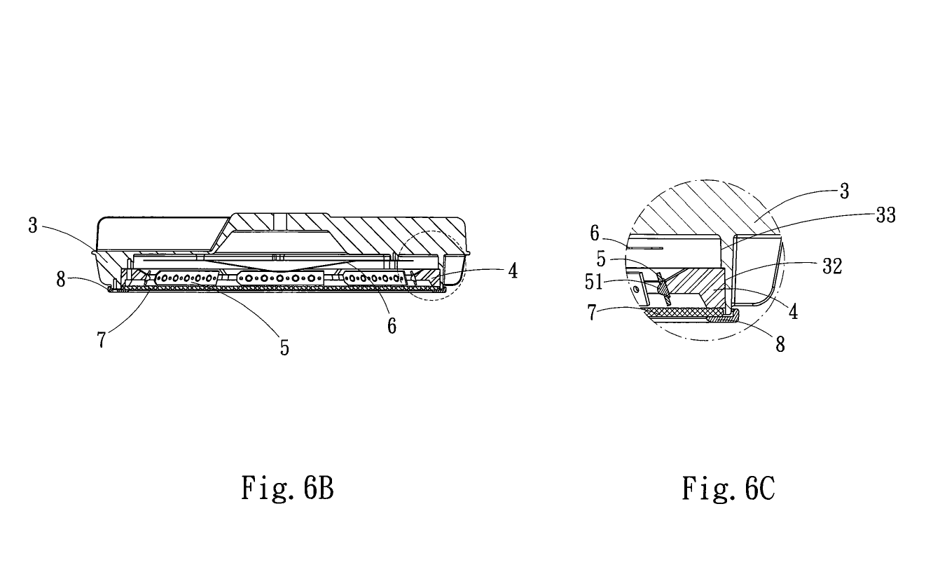

Please refer to FIG. 5, and FIGS. 6A˜6C. The lamp cover 7 is covered on an opening of the LED room 32 of the heat dissipation base 3, wherein the lamp cover 7 can be made of transparent glass, translucent glass, or glass having both transparent and translucent portions.

The edge frame 8 is screwed at the outer edge of the opening of the LED room 32 for fixing the lamp cover 7.

Please refer to FIG. 2, FIG. 3 and FIG. 4. As assembling the lamp structure of the present invention, the heat dissipation base 3 is bolted between the lower portions of the two vertical supports 13 and the rotational disc 12 on the fixing support 1 is fixed on the wall for providing the turning function. The LED holder 4 is embedded and screwed in the LED room 32 of the heat dissipation base 3 and the PCBs 5 are screwed on the first inclined planes 41 of the LED holder 4, and the wide angle illumination range can be controlled through the angle of the inclined planes 41. The heat produced as lighting can be dissipated by the heat dissipation fins 31 on the heat dissipation base 3. Then, please refer to FIG. 5 and FIG. 6C, the light reflection board 6 is screwed in the light reflection room 33, the lamp cover 7 is covered at the opening of the LED room 32 and the edge frame 8 is screwed at the outer edge of the LED room 32, wherein the dazzle of LED lamp can be effectively reduced by using the light reflection board 6 and the lamp cover 7.

Please refer to FIG. 3 and FIG. 4. When the LED bulbs 51 on the PCBs 5 are lighted, the produced heat, through the LED holder 4, can be rapidly transmitted to the heat dissipation base 3 and also the heat dissipation fins 31, so as to dissipate the heat from the LED bulbs 32.

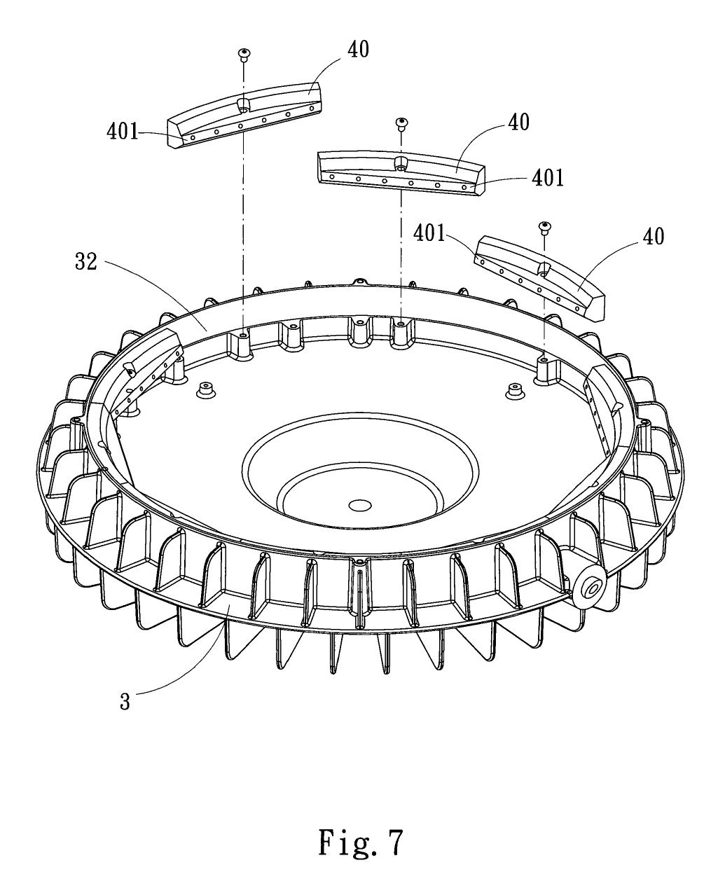

Please refer to FIG. 7. In one embodiment of the present invention, the LED holder 4 can be composed of a plurality of holder pieces 40 which are screwed in the LED room 32. The holder pieces 40 can have second inclined planes 401 at a side facing the center of circle for placing the PCBs 5 (as shown in FIG. 1).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wide angle LED lamp structure, comprising:
a fixture;
a control box, mounted on the fixture;
a heat dissipation base, bolted at the lower portion of the fixture and surrounded by a plurality of heat dissipation fins at the peripheral surface thereof, wherein the heat dissipation base has an LED room mounted at the bottom thereof and a light reflection room located above the LED room;
an LED holder, being a frame matched with and mounted in the LED room, and having a plurality of first inclined planes mounted annularly on the inner side thereof;
a plurality of PCBs, each having a plurality of LED bulbs mounted thereon and being screwed on the first inclined plane of the LED holder through fixing elements, which are spaced at intervals corresponding to the LED bulbs;
a light reflection board, mounted in the light reflection room;
a lamp cover, covered at the bottom of the heat dissipation base; and
an edge frame, mounted at the outer edge of an opening of the LED room at the bottom of the heat dissipation base.

2. The wide angle LED lamp structure as claimed in claim 1, wherein the fixing elements are screws.

3. The wide angle LED lamp structure as claimed in claim 1, wherein the heat dissipation base is made of a metal having high heat dissipation efficiency.

4. The wide angle LED lamp structure as claimed in claim 3, wherein the heat dissipation base is made of aluminum.

5. The wide angle LED lamp structure as claimed in claim 3, wherein the heat dissipation base is made of copper.

6. The wide angle LED lamp structure as claimed in claim 1, wherein the edge frame is screwed on the heat dissipation base.

7. The wide angle LED lamp structure as claimed in claim 1, wherein the fixture has a rotational disc mounted thereon.

8. The wide angle LED lamp structure as claimed in claim 1, wherein the number of the LED bulbs on the PCB is variable according to requirements.

9. The wide angle LED lamp structure as claimed in claim 1, wherein the heat dissipation base and the LED holder are integrally formed.

10. The wide angle LED lamp structure as claimed in claim 1, wherein the LED holder is composed of a plurality of holder pieces, and each holder piece has a second inclined plane mounted at a side facing the center of circle.

11. The wide angle LED lamp structure as claimed in claim 1, wherein the lamp cover is made of transparent glass.

12. The wide angle LED lamp structure as claimed in claim 1, wherein the lamp cover is made of translucent glass.

13. The wide angle LED lamp structure as claimed in claim 1, wherein the lamp cover is made of glass having both transparent and translucent portions.

14. The wide angle LED lamp structure as claimed in claim 1, wherein the LED holder is embedded and screwed in the LED room.
